(19) United States
(12) Patent Application Publication
(10) Pub. No.: US 2003/0186746 A1
(43) Pub. Date: Oct. 2, 2003

(54) Game apparatus for use with personal digital assistant

(75) Inventor: Tsung-Jen Chuang, Taipei (TW)

Correspondence Address: NIXON PEABODY, LLP, 8180 GREENSBORO DRIVE, SUITE 800, MCLEAN, VA, 22102, US

(73) Assignee: LITE-ON TECHNOLODY CORPORATION, Taipei (TW)

(21) Appl. No.: 10/291,422

(22) Filed: Nov. 12, 2002

(30) Foreign Application Priority Data
Apr. 1, 2002 (TW) 091204109

(51) Int. Cl. G06F 19/00; G06F 17/00

(52) U.S. Cl. 463/42

(57) ABSTRACT

The present invention provides a game apparatus for use with a personal digital assistant to surf over the wireless Internet. The game apparatus includes a controlling device and a connecting part. The controlling device includes a game circuit, a microprocessor, a wireless communication module, and a vibrator. The connecting part has a first end and a second end detachably connected to the controlling device and the PDA respectively. The wireless communication module provides a user for playing Internet online game using the PDA.

This application claims priority of Taiwan Patent Application No. 91204109 filed on Apr. 1, 2002.

### FIELD OF INVENTION

The present invention relates to a game apparatus, and more particularly, to a game apparatus for use with a personal digital assistant.

### BACKGROUND OF THE INVENTION

With the development of Information Technology, portable electronic devices having lightweight and compact features have emerged successively. For example, mini-type data processing devices such as Hand-held Terminal, Notebook, Web Pad, Personal Digital Assistant (PDA), and Mobile Phone have been gradually popular. However, as the size of these portable electronic devices shrink, this size-shrinkage arrangement accordingly sacrifices the space accommodating input devices. So these mini-type input devices (for example, keypad or button) are usually too undersized to meet the need of the users. For example, the user feels uncomfortable when utilizing the mini input devices, or the mini input devices do not provide enough input accuracy or speed to the user. Therefore, even these mini-type electronic devices can compete with the desktop personal computer with regard to capabilities of data processing and storage; the desktop computer still has its advantages with regard to the operation convenience.

PDA is a popular portable electronic device not having traditional typewriter or other types of keypads, and the front face of PDA is usually a LCD. Generally, on the PDA, there are few controlling buttons, and a stylus is provided to the user for inputting information on the LCD display. The PDA stores the user's handwriting into bitmap form and needs substantial memories to store the data thus limiting the operating capability of the PDA. Additionally, the PDA can be equipped with handwriting-recognition software, which enables translating the handwriting information into codes or characters effectively. Generally, the PDA is provided with a virtual keypad, and the user may selectively have the virtual keypad displayed on the LCD display. Either the controlling buttons on PDA or the stylus may move the cursor to the desired button location on the virtual keypad, thus facilitating the input of data.

However, inputting method described above is so slow that it is far from the promptness the traditional keyboard can provide.

The typical PDA could not provide a keypad under the display area due to its size limitation, and therefore a new solution of an external keypad emerges. When the keypad is not needed, the user only brings the PDA with him/her and the external keypad is separated from the PDA. And when the user needs to input a great amount of information, the user can connect the external keypad to the PDA to improve the input speed.

There still is deficiency when the user plays games using the PDA either by the existing buttons or the external keypad. Furthermore, not each commercially available PDA has the function surfing over the Internet wirelessly. Therefore, to meet the need, a wireless communication module is provided to cooperate with a PDA thus allowing the user to connect to the Internet network wirelessly.

Additionally, the state-of-art mechanism used to connect an external keypad module with PDA is not adjustable and one specific type of external keypad module only matches with one corresponding type of PDA instead of all types of PDA.

As is described above, it is desirable to provide a game apparatus including a wireless communication module allowing the user to surf over the Internet and, on the other hand, allowing the user to input data into a portable electronic devices, e.g. PDA, rapidly. And, preferably, the game apparatus is adjustable to cope with various types of PDA maximizing its utility.

### SUMMARY OF THE INVENTION

The present invention provides a game apparatus connectable with a PDA allowing a user to surf over the Internet wirelessly. The game apparatus includes a controlling device and a connecting part by which the controlling device is connected to the PDA.

The controlling device includes a game circuit, a microprocessor, a wireless communication module, and a vibrator, such as the shock motor.

The connecting part has a first end and a second end detachably connected to the controlling device and PDA respectively. When the user plays games using the PDA, the controlling device, using the microprocessor and game circuit, transmits the user's desired information through the connecting part to the PDA. On the other hand, based on the instructions of games played in the PDA, the microprocessor in the controlling device sends the information to the user via the vibrator.

The wireless communication module constructed in the controlling device can provide function of surfing over the Internet. So, the game device allows the user to play the on-line games over the Internet.

This and other aspects of the present invention will become clear to those of ordinary skill in the art after having read the following detailed description of the preferred embodiment which is illustrated in the various figures and drawings.

### BRIEF DESCRIPTION OF THE DRAWINGS

FIG. 1 shows a game apparatus of exemplary embodiment of the present invention in functional block diagram that is connected with a PDA;

FIG. 2a is a schematic representation of a game apparatus in accordance with a first embodiment of the present invention and a PDA;

FIG. 2b is a schematic representation showing how a game apparatus of FIG. 2a connects to a PDA;

FIG. 3a is a schematic representation of a game apparatus in accordance with a second embodiment of the present invention and a PDA;

FIG. 3b is a schematic representation showing how a game apparatus of FIG. 3a connects to a PDA;

FIG. 4a is a schematic representation of a game apparatus in accordance with a third embodiment of the present invention and a PDA; and

FIG. 4b is a schematic representation showing how a game apparatus of FIG. 4a connects to a PDA.

### DETAILED DESCRIPTION

The present invention provides a game apparatus connectable with a PDA allowing a user to surf over the Internet wirelessly. The game apparatus includes a controlling device 5 and a connecting part 3 for connecting the controlling device 5 to the PDA 1.

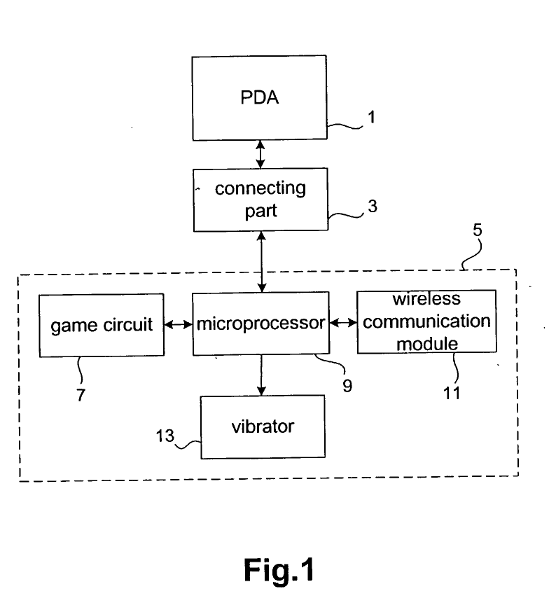

Referring to FIG. 1, FIG. 1 is a block diagram of a game apparatus connecting with a PDA. The controlling device 5, e.g. joystick or game pad, includes a game circuit 7, a microprocessor 9, a wireless communication module 11, and a vibrator 13, such as the shock motor.

The wireless communication module 11, for example Global System for Mobile communications (GSM), General Packet Radio Service (GPRS), Code Division Multiple Access (CDMA), Wireless LAN 802.11b (WLAN), infrared module, or blue-tooth module, at least includes a radio frequency (RF) circuit. The PDA 1 is provided to surf over the Internet wirelessly when connecting to the controlling device 5.

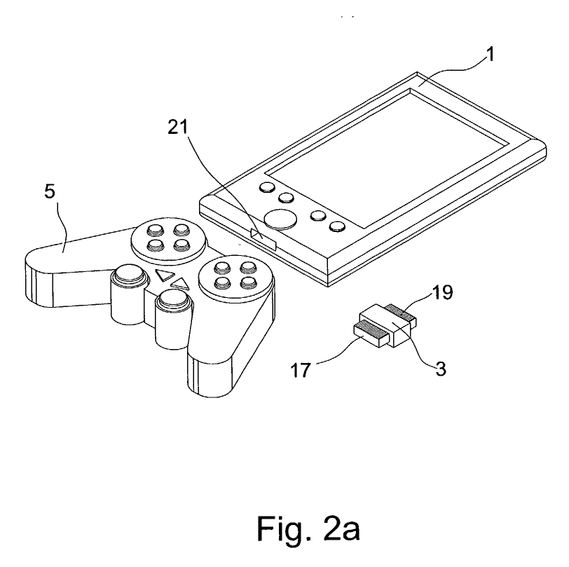

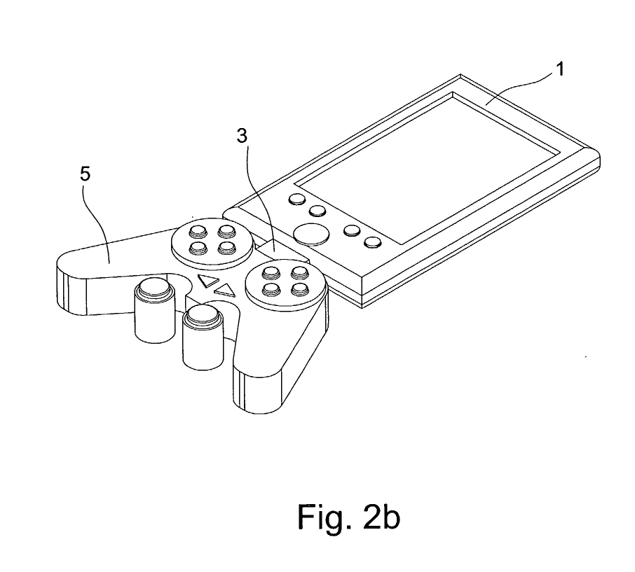

Referring to FIG. 2a and FIG. 2b, the connecting part 3 has a first end 17 and a second end 19 detachably connected to the controlling device 5 and PDA 1 respectively. Additionally, the specification of the second end 19, for example, Universal Serial Bus (USB) or personal computer memory card international association (PCMCIA) varies correspondingly according to the specifications supported by various PDAs.

Referring back to the block diagram of FIG. 1, the connecting part 3 is connected to the PDA 1 and controlling device 5 respectively. When the user plays games using the PDA 1, the controlling device 5, using the microprocessor 9 and game circuit 7, transmits the user's desired information through the connecting part 3 to the PDA 1. On the other hand, based on the instructions of games played in the PDA 1, the microprocessor 9 in the controlling device 5 sends the information to the user via the vibrator 13.

For example, when the user plays racing-car game, the PDA 1, according to the road surface, i.e. the bump or pit, encountered by the car transmits a force feedback signal to the microprocessor 9 through the connecting part 3. And then the microprocessor 9 sends the force feedback signal to the vibrator 13, and the vibrator 13 vibrates to simulate feeling of real car driving thus enhancing the enjoyment of the computer game.

In additional, more and more game developers set out to provide a game platform supporting the PDA 1 other than supporting the PC. As a result, when the user combines the game apparatus of the present invention with the PDA 1, the wireless communication module 11 constructed in the controlling device 5 can provide the function of surfing over the Internet for the PDA 1. So, the game device of the invention allows the user to play the Internet on-line games, such as games of real-time tactics game or role-play game.

The following are embodiments of a game apparatus of the invention that is connectable with a PDA 1.

The first embodiment of the invention is disclosed in FIG. 2a and FIG. 2b. FIG. 2a is a schematic representation of a game apparatus of the first embodiment and a PDA 1 in explosive form. As shown in FIG. 2a, the bottom of the PDA 1 has a first slot 2l. And the controlling device 5 has a second slot (not shown) corresponding to the first slot 21. The connecting part 3 has a first end 17 and a second end 19. FIG. 2b is a schematic representation of a game apparatus connecting to the PDA 1. As shown in FIG. 2b, the game apparatus, via the first end 17 of the connecting part 3, is detachably connected to the controlling device 5, and, via the second end 19, is detachably connected to the PDA 1.

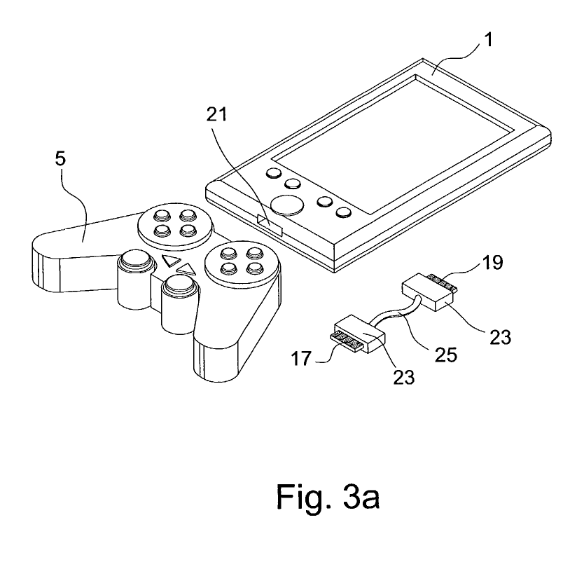

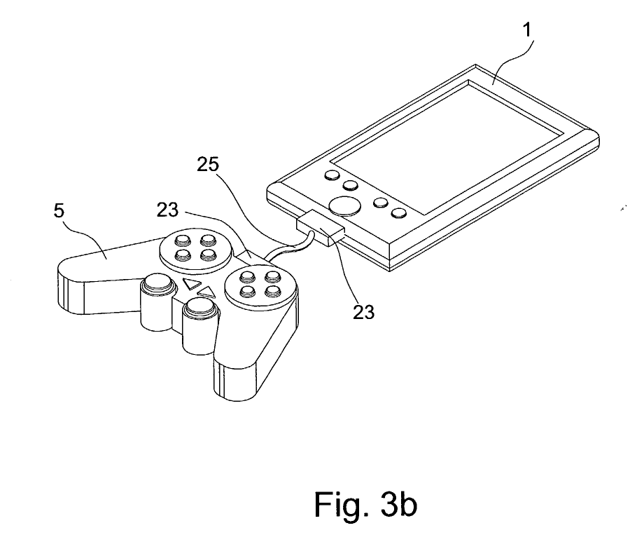

The second embodiment of the invention is disclosed in FIG. 3a and FIG. 3b. FIG. 3a is a schematic representation of a game apparatus of the second embodiment and a PDA 1 in explosive form. As shown in FIG. 3a, the bottom of the PDA 1 has a first slot 21, and the controlling device 5 has a second slot (not shown) corresponding to the first slot 21. The connecting part 23 has a first end 17 and a second end 19. Different from the first embodiment, the connecting part 23 provides a longer connecting line 23 thus allowing the user to have different options according to his fondness and habit. FIG. 3b is a schematic representation of a game apparatus of the second embodiment connectable with a PDA 1. As shown in FIG. 3b, the game apparatus, via the first end 17 of the connecting 23, is detachably connected to the controlling device 5, and, via the second end 19, is detachably connected to the PDA 1.

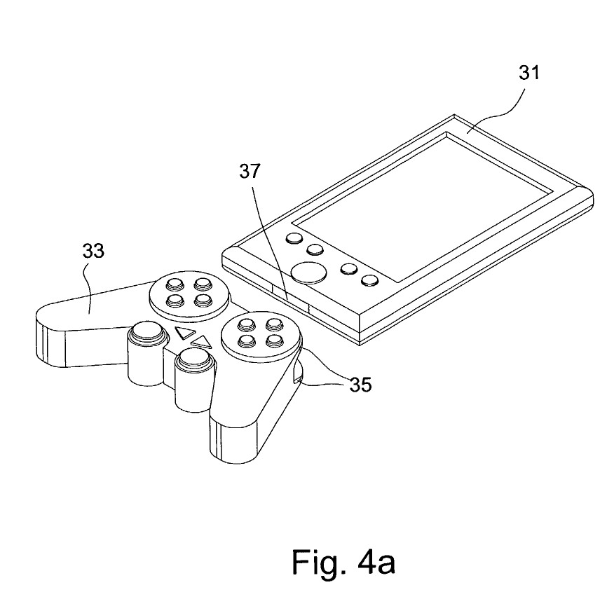

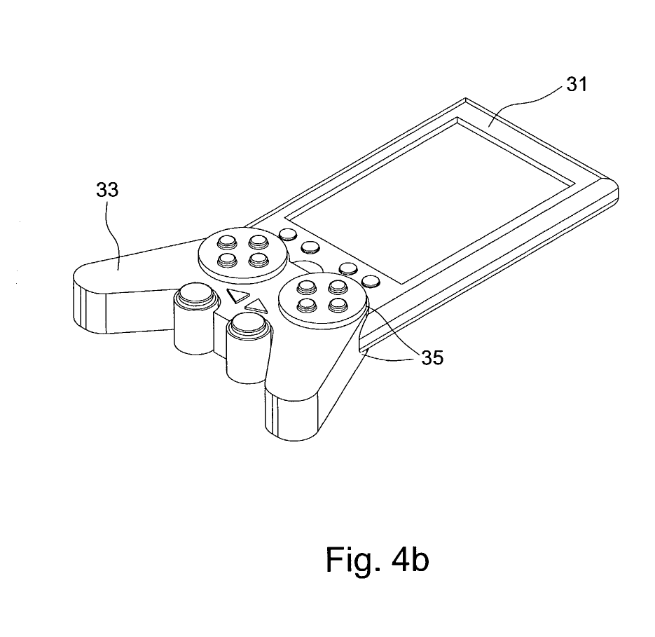

The third embodiment is disclosed in FIG. 4a and FIG. 4b. FIG. 4a is a schematic representation of a game apparatus of the third embodiment and a PDA 31. As shown in FIG. 4a, the bottom of the PDA 31 has a first infrared port 37 for receiving/emitting signal, and the controlling device 33 has a second infrared port (not shown) corresponding to the first infrared port 37. The game apparatus, using the infrared port, exchanges signal with the PDA 31. Under this embodiment, the connecting part is then a wireless connection (not shown) between the controlling device 33 and the PDA 31. In addition, to facilitate the user's operation, the front end of the controlling device 33 has a shape of a clamp type 35. So, when the user play games wirelessly, the controlling device 33 is clamped to the bottom of the PDA 31, as shown in FIG. 4b.

Those skilled in the art will readily observe that numerous modification and alterations of the apparatus may be made while retaining the teaching of the invention. For instance, although the preferred embodiment of the invention is disclosed with the specification of the connecting part 3 being USB or PCMCIA, the present invention is not limited to embodiment(s) described above. Typically, the second end 19 of the connecting part 3 may be a serial port for detachably connecting to the PDA 1. The second end 19 of the connecting part 3 has numerous modifications and alterations allowing the controlling device 5 to connect to various specifications of the PDA 1.

Those skilled in the art will readily observe that numerous modifications and alternations of the apparatus may be made while retaining the teaching of the invention. Accordingly, the above disclosure should be construed as limited only by the metes and bounds of the appended claims.

1 A game apparatus for use with a personal digital assistant, comprising:
a controlling device, said controlling device comprising a wireless communication module; and
a connecting part having a first end and a second end, said first end being detachably connected to said controlling device, and said second end being detachably connected to said personal digital assistant.

2 The game apparatus of claim 1, further comprising a vibrator provided within an internal space of said controlling device, said vibrator generating a vibration movement responsive to a feedback signal from said personal digital assistant.

3 The game apparatus of claim 1, wherein said wireless communication module comprises a module of global system for mobile communications.

4 The game apparatus of claim 1, wherein said wireless communication module comprises a module of general packet radio service.

5 The game apparatus of claim 1, wherein said wireless communication module comprises a module of code division multiple access.

6 The game apparatus of claim 1, wherein said wireless communication module comprises a module of wireless LAN 802.11b.

7 The game apparatus of claim 1, wherein said wireless communication module comprises a bluetooth module.

8 The game apparatus of claim 1, wherein said wireless communication module comprises an infrared communication module.

9 The game apparatus of claim 1, wherein said controlling device comprises a joystick.

10 The game apparatus of claim 1, wherein said controlling device comprises a game pad.
